(19) United States
(12) Patent Application Publication
(10) Pub. No.: US 2009/0158790 A1
(43) Pub. Date: Jun. 25, 2009

(54) Vehicle Immobilization System

(76) Inventor: Richard D. Oliver, Grosse Ile, MI (US)

Correspondence Address: DICKINSON WRIGHT PLLC, 1875 Eye Street, NW, Suite 1200, WASHINGTON, DC, 20006, US

(21) Appl. No.: 12/340,118

(22) Filed: Dec. 19, 2008

Related U.S. Application Data
(60) Provisional application No. 61/016,042, filed on Dec. 21, 2007.

(51) Int. Cl. G05G 5/00; B60R 25/08

(52) U.S. Cl. 70/202; 188/265; 303/89

(57) ABSTRACT

A vehicle immobilization system having a controller and a brake system that is capable of maintaining the vehicle brakes in an engaged position to prevent rotation of the wheels.

### CROSS REFERENCE TO RELATED APPLICATION

This utility patent application claims the benefit of U.S. Provisional Patent Application Ser. No. 61/016,042 filed Dec. 21, 2007, entitled “Vehicle Immobilization System.”

### BACKGROUND OF THE INVENTION

1. Technical Field

This present invention is directed to a vehicle immobilization system that actively locks the four wheels of a vehicle in place when activated.

2. Discussion

Over the years vehicle theft has been and continues to be a significant problem. In response to vehicle theft, car manufacturers and aftermarket companies are consistently attempting to make it harder to steal a vehicle.

A variety of prior art anti-theft devices such as, steering wheel locks, steering column locks, burglar alarms, automotive hood locks, ignition locks, truck guards, park interface locks, and computer coded keys, particularly with rolling code keys, have reduced vehicle theft but so far have not addressed the theft of automobiles or vehicles through the towing of the vehicle with an easy to use unobtrusive and easily added system. Theft of vehicles using a towing vehicle is a simple and fast method for thieves to steal a vehicle and is very difficult for existing systems to prevent. After market companies have developed a few devices that immobilize the vehicle to address towing concerns. These devices use primarily mechanical methods and are generally difficult to operate or may be easily circumvented. Therefore, there is a need for an integrated control system that monitors vehicle status conditions to safely engage the brake system to lock the wheels of the vehicle in place and is easy to operate and difficult to circumvent.

### SUMMARY OF THE INVENTION

In view of the above, the present invention is directed to a safe and easy to use vehicle immobilization system. The vehicle immobilization system generally includes a controller for monitoring vehicle status inputs and providing signals to lock the brakes in place thereby immobilizing the wheels from turning.

The vehicle includes a braking system capable of preventing each vehicle wheel from turning. A vehicle immobilization system is added to the vehicle to control the braking system to engage the brakes and prevent the wheels from turning. The vehicle immobilization system includes a controller for receiving various vehicle status signals and outputting signals to control the braking system. The vehicle immobilization system further includes a brake mechanism for engaging and disengaging the brakes in response to the output signal from the controller.

The brake mechanism may be a solenoid to lock the brake arm in place, a control valve to maintain or release pressure in the brake fluid lines, or the vehicle ABS system. the vehicle immobilization system may also include a pressure device for automatically building pressure in the brake lines for engaging the brakes when desired.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a partial perspective view of the interior of an automobile passenger compartment showing an exemplary embodiment of a vehicle immobilizing system;

FIG. 2 is a side elevational view of the exemplary embodiment of a vehicle immobilization system;

FIG. 3 is a plan view of an exemplary embodiment of a vehicle immobilization system;

FIG. 4 is a schematic view of an exemplary embodiment;

FIG. 5 is a schematic view of an exemplary embodiment;

FIG. 6 is a schematic view of an exemplary embodiment;

FIG. 7 is a schematic view of an exemplary embodiment;

FIG. 8 is a schematic view of a valve assembly in an unlocked position;

FIG. 9 is a schematic view of a valve assembly in a locked position; and

FIG. 10 is a schematic view of a valve assembly including a pressure module.

### DETAILED DESCRIPTION OF THE PREFERRED EMBODIMENT

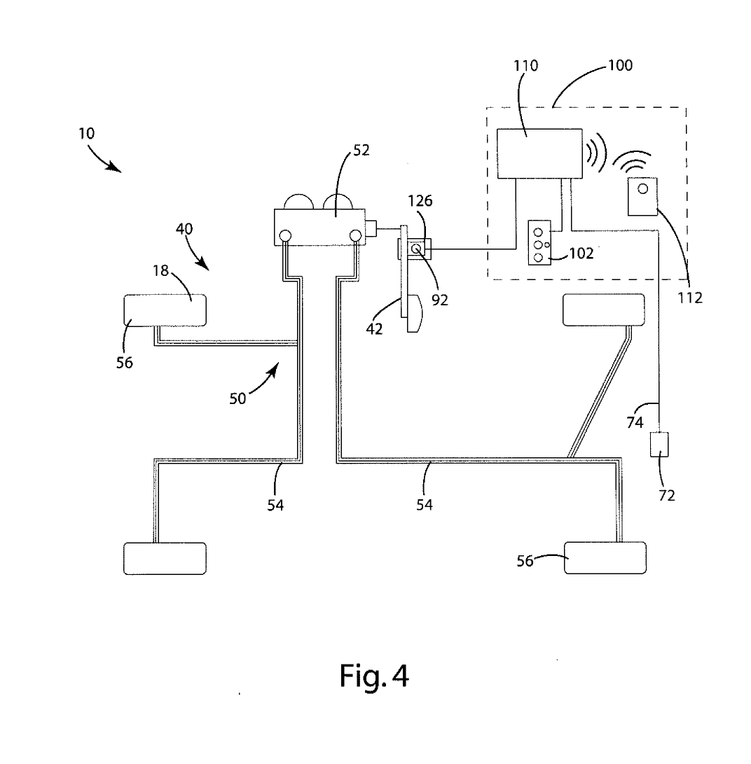

The present invention is directed to a vehicle immobilization system generally illustrated as 100 in FIGS. 4-7 and 10 which is generally configured to fit within a vehicle 10 to prevent or reduce tow away thefts.

The vehicle 10 generally includes a seat 12, a steering column 14, a steering wheel 16, wheels 18, an instrument panel 20, a shift mechanism 30, and a brake system 40. The vehicle 10 can be any vehicle that drives wheels to directly or indirectly propel the vehicle forward. The most common application for the vehicle immobilization system 100 is generally automobiles such as cars and trucks.

All modern vehicles generally include a brake system 40 that generally includes brakes 56 having a brake pad driven by a piston. The brake pads engage a rotor or drum coupled to the wheels 18 of the vehicle. As the brake pads engage the rotor or drum, the brake system 40 may prevent the wheels from turning or allow the wheels to turn. Although less common in vehicles without ABS systems, the brakes 56, specifically the pistons, are hydraulically connected to a master cylinder 52 by hydraulic lines 54. For vehicles without ABS systems, the brakes 56, hydraulic lines 54 and master cylinder 52 generally form the brake system 40 of a vehicle 10. The master cylinder 52 is generally controlled by a brake pedal 42.

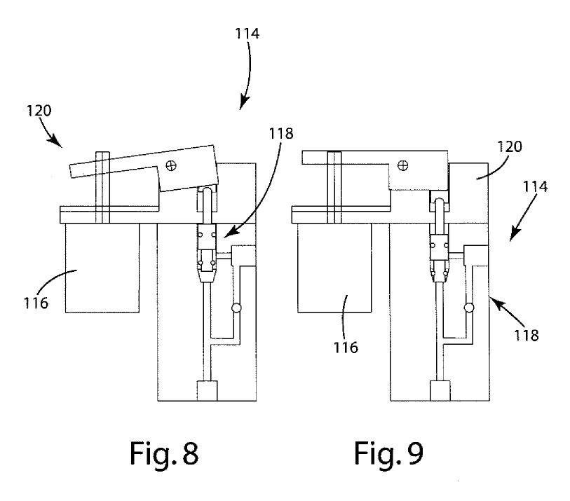

In comparison, vehicles with ABS systems 60, as generally illustrated in FIG. 8, generally include, in addition to the components identified above, at least one wheel sensor 62, an ABS controller (or module) 64, and a hydraulic modulator (or ABS actuator) 66. The ABS system 60 generally functions as is well known in the art.

The system 100 will first be described for use with a brake system 40 that does not include an ABS system 60 and then with a brake system 40 that includes an ABS system 60. The vehicle immobilization system 100 may be installed as original equipment option by the vehicle manufacturer or as an after market option by the owners of a vehicle. As the vehicle immobilization system 100 is an anti-theft device, it may be desirable to be available as an original equipment option and it may be further desirable to incorporate the functionality and control methods into the existing onboard computer systems found on vehicles today. For example, the vehicle immobilization system may be added to some OEM vehicles by adding additional functionality to existing engine management control system computers, ABS modules or controllers, or any of the many other controllers found in vehicles today. Of course, the functionality of the vehicle immobilization system may be added through separate controllers and systems or separate controllers that interact with existing OEM components.

In a vehicle without an ABS system, as illustrated in FIGS. 4-6 and 10, the vehicle immobilization system 100 generally includes a controller 110 that interfaces with the brake system 40 to prevent or reduce tow away thefts. For original equipment, the controller 110 may be incorporated into existing vehicle controllers, such as vehicle computers, engine management systems, or ABS controllers. However, the Figures illustrate a separate controller, which may be applicable to both after market and original equipment. In general, the controller 110 receives inputs regarding the vehicle's status and to provide outputs to control the engagement and disengagement of the brakes.

Even with incorporation into a vehicle as an original equipment option, there may be various methods of implementation to provide immobilization of the vehicle through the brake system 40. Some variations may occur when a vehicle is equipped with or without ABS. The vehicle immobilization system 100 is generally activated by receiving at least one input or status signal showing that the vehicle is at rest and at least one input or status signal that the operator of the vehicle desires to arm the system. Of course, the vehicle immobilization system 100 may be configured such that an operator input regarding the desire to arm the vehicle is automatic when the vehicle is at rest and certain operational conditions are met, such as the vehicle being placed in park and then the ignition being turned off.

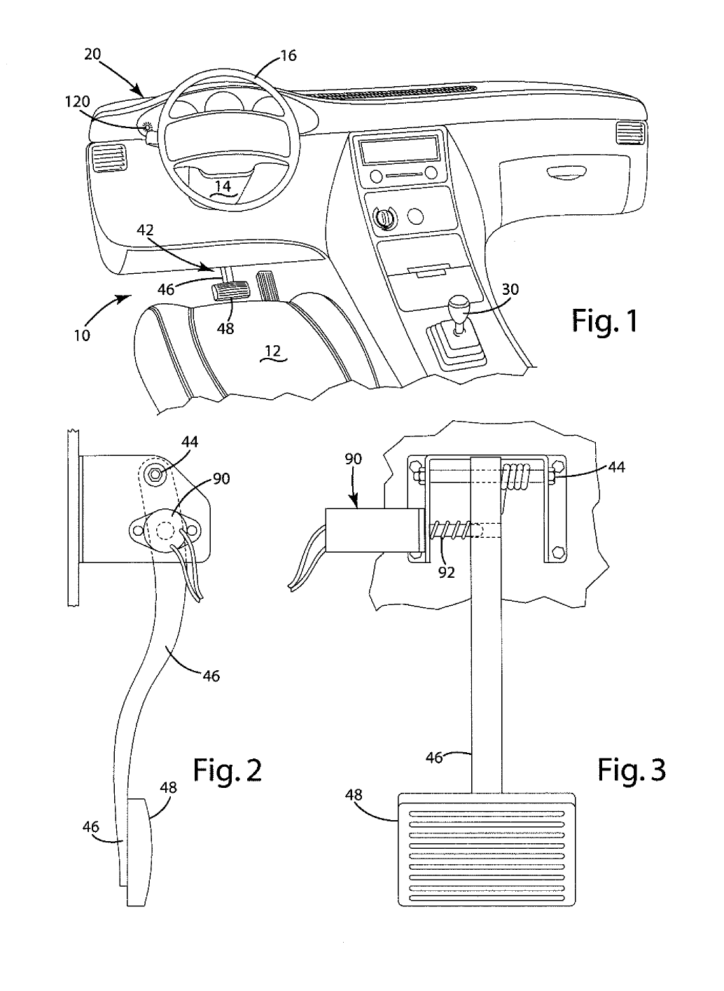

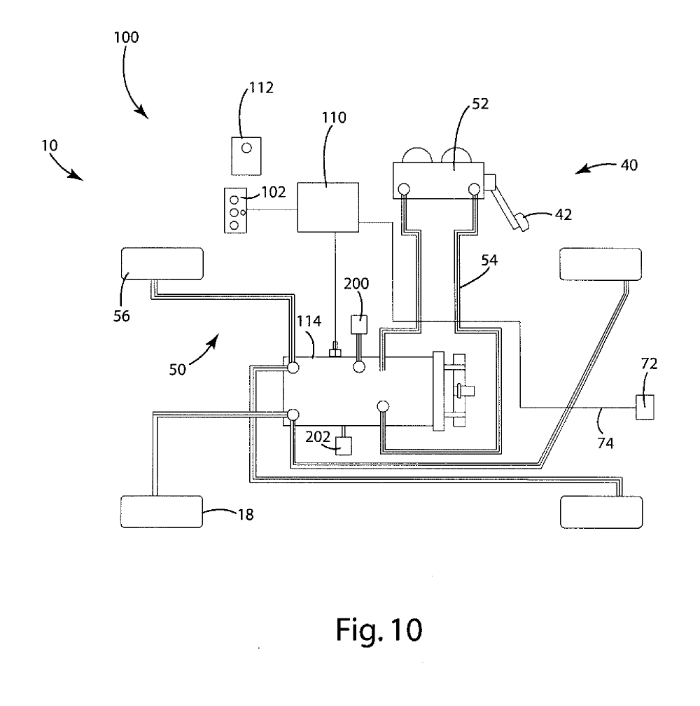

In FIGS. 1-5, the system uses a brake arm solenoid lock having a shaft 92 that interfaces with the brake pedal arm 46. More specifically, as illustrated in FIG. 2, an actuation device having a solenoid or motor 90 coupled to a structural member pushes a pin 92 into a recess on the brake arm 46 to lock the brake arm 46 in a depressed position. The immobilization system 100, by locking the brake arm 46 in a depressed position, will maintain pressure in the brake system 40 thereby keeping the brakes engaged even when the vehicle engine is not running. The system may include in non-ABS systems a pressure creation device 200 as illustrated in FIG. 10. This pressure creation device 200 may be applied to any system 40 particularly to, non-ABS systems such as the systems illustrated in FIGS. 4-6.

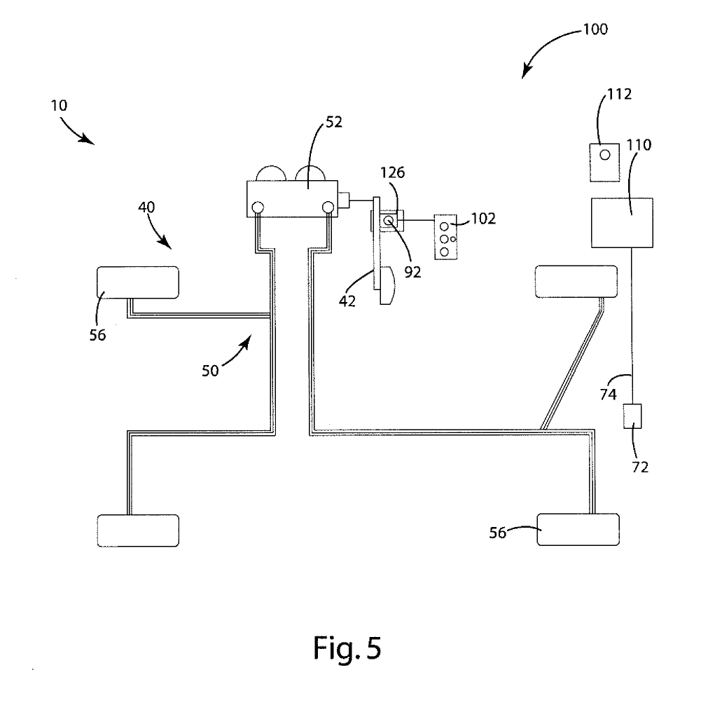

As illustrated in FIG. 4, the immobilization system 100 further includes the controller 110 which is in communication with remote device 112. The vehicle operator uses the remote device 112 to communicate to the controller 110 that the immobilization procedure should be initiated. As described in greater detail below, the controller 110 only initiates the immobilization sequence after receiving certain vehicle status signals that the vehicle is in a stopped state. In the exemplary examples shown schematically in FIGS. 4 and 5, the brake pedal must also be depressed sufficiently to engage the brake pads sufficiently against the drums and rotors to prevent the wheels from turning. Therefore, the controller 110 will not move the shaft 92 into engagement with the brake arm 46 until after it is sufficiently depressed. The brake arm 46 must also be sufficiently depressed so the shaft 92 may interlock with the brake arm. For clarification, the brake pedal 42 generally includes a brake arm 46 fixed to a pivot axis 44 and a free end 48 which is depressed by the operator.

The system 100 in FIG. 5 is similar to the system 100 in FIG. 4 with the status light 102 being wound to the mechanism 126 on the brake arm 42, instead of the controller 110.

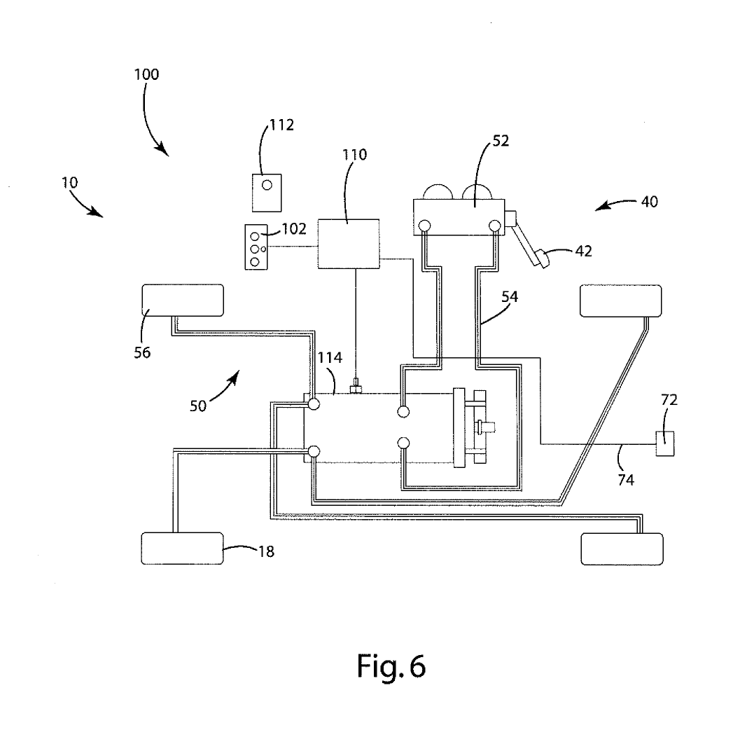

The system 100 illustrated in FIG. 6 eliminates the mechanism 126 having an actuation device 90 and shaft 92 engaging the brake arm 42. Instead, the system 100 includes a valve assembly 114 through which the hydraulic lines 54 pass, located between the master cylinder 52 and the brakes 56. The controller 110 is in communication with the valve assembly 110. Although the valve assembly 114 may use only one valve to lock the brake lines, it may be advantageous to use a separate valve for each brake 56. Therefore, if one line 54 loses pressure, the other liens will still retain pressure. The valve assembly 114 may also be any actuator or module capable of maintain pressure within the hydraulic lines.

As illustrated in FIG. 10, for non-ABS vehicles, the system 100 may include a pressure creation device 200 and pressure monitor 202. Therefore, in response to a drop in fluid pressure determined by the pressure sensor 202, the pressure creation device 200 may supply pressure to maintain engagement of the brakes while the system 100 is armed. The pressure creation device is particularly useful in building the original pressure to engage the vehicle brakes as well as ensuring that the brake system maintains a minimum pressure.

As further illustrated in FIG. 4, the system 100 may further include a signal output 102 that informs the vehicle operator of the status of the system 100. For example, the system 100 may communicate that the system 100 is not armed (brakes disengaged), armed (engaged brakes), or a fault in engaging or keeping the brakes engaged. As further illustrated in FIG. 4, the controller 110 may be electrically coupled to the brake light 72 to receive a brake status signal 74. For example, in operation, the controller may require a brake light on signal before engaging the pin into the brake arm in response to an input to the remote 112.

For vehicles not having anti-lock brake systems or ABS, the vehicle immobilization system 100 may be added to a vehicle 10 as an original equipment option or as an aftermarket feature for a vehicle. To activate or arm the vehicle immobilization system 100 installed as an original equipment option in a vehicle not having ABS, an operator would either directly or indirectly activate the system 100 in response to which, the system would look for a stopped condition of the vehicle. Upon determining the vehicle is stopped, the controller 110 would initiate a sequence of events that would cause the brakes 56 at the wheels 18 to lock or engage to prevent the wheels 18 from turning. More specifically, the controller 110 which may be integrated into existing controllers on the vehicle or added as an additional controller 110 will look for an input such as the ignition being turned off, the vehicle being placed into park, the parking brake being engaged, or a separate input from a remote 112 showing the that vehicle is in a stopped state. As a safety measure, the controller 110 may look for multiple inputs which may include, in addition to those mentioned above, an engine RPM of zero, a wheel speed of zero, a pressure high in the hydraulic system 50, or even a brake light input. For example, if the operator directly activates the system 100 by a remote 112, the controller 110 upon receiving the desired activation signal from the remote 112 would look for an input that the vehicle is stopped. These inputs could be the ignition being turned to zero or off, the engine RPM being zero, the wheel speed being zero, the car being placed in park, the parking brake engaged, a pressure high in the hydraulic system or a brake pedal position such that the vehicle wheels would be incapable of turning under normal operating conditions. Typically, the parking brake signal is used for only electrically activated parking brakes which are not applied manually by a force applied by the user. This avoids a stopped state signal to the controller when the parking brake is not fully applied. The system uses vehicle status signals and in some instances redundant stopped condition vehicle status signals to ensure that the system would not energize in response to the operator accidentally sending an engagement signal to the controller.

In a non-ABS vehicle such as in FIGS. 4-6, if no separate mechanism for building pressure is included, then the system would require the operator to depress the brake pedal to a specified position that would build the necessary pressure within the hydraulic system 50 to reach a level that when maintained after the operator leaves the vehicle, the brakes continue to lock the wheels in place. To automate the building of pressure, a separate piston, or pressure module (illustrated as 200 in FIG. 10) or electrically actuated master cylinder may also be used to build sufficient pressure in the hydraulic system 50, without the need for pushing of the brake arm by the operator, thereby allowing engagement of the system 100 remote from the vehicle. The pressure may be maintained in the hydraulic system 50 by locking the brake arm 46 in a depressed position (FIGS. 4 and 5) or through an additional valve system 114 that traps pressure in the hydraulic lines 54 extending to the brakes (FIGS. 6 and 10). The trapped pressurized fluid maintains the brakes in an engaged position and thereby prevents the wheels from turning. Of course, one skilled in the art would recognize that the method steps outlined above are exemplary and that many variations thereof may be used. For example, the operator may be required to first press the brake pedal 42 such that the brake arm 46 is in a depressed position and then provide one or more inputs such as activating the remote 112, or placing the vehicle into park and turning off the ignition before the controller 110 initiates sequences to lock the brakes, such as locking the brake arm in a depressed position using a motor 90 having a shaft 92 to engage the brake arm 46 or if the system automatically engages such as through the valve system 114 using a motor or solenoid 116 to activate a valve 118 trapping the high pressure in the brake lines and maintaining the brakes in an engaged position. The operator then may remove their foot from the brake pedal and leave the vehicle.

The above described systems for non-ABS vehicles may also be used with vehicles equipped with ABS systems. The system 100 described above would work well as an aftermarket option to a vehicle having an ABS vehicle brakes. The system may also include variations particular to ABS brake systems as described below and in particular use components of the ABS braking system to implement the vehicle immobilization system. When implemented as described below as part of the vehicle's existing ABS system, the system has reduced implementation cost.

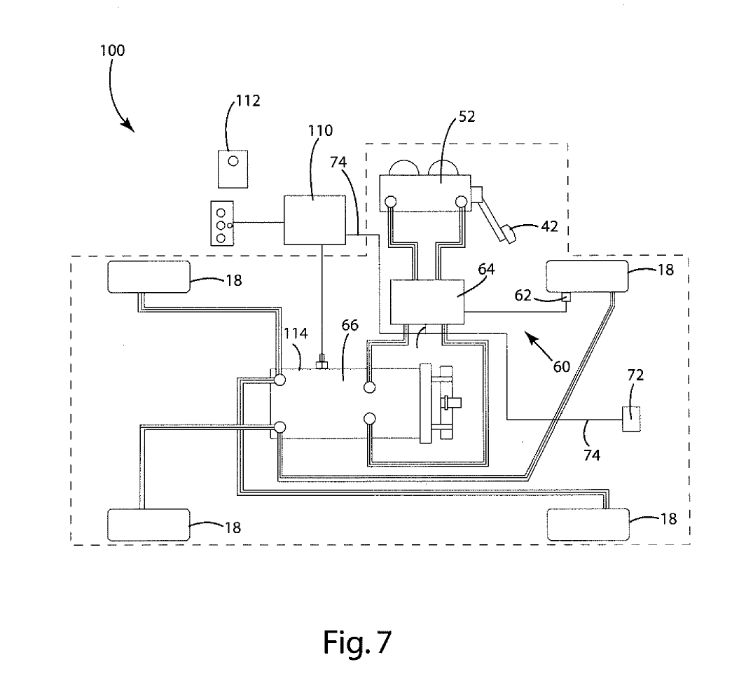

Vehicles having an ABS system 60, as illustrated in FIG. 8 generally include, in addition to the components identified above, at least one wheel sensor 62, an ABS controller (or module) 64 and a hydraulic modulator (or ABS actuator) 66. An ABS equipped vehicle may be easily modified to include the vehicle immobilization system 100, as the vehicle immobilization controller 110 may be built into various ABS controllers on the vehicle such as what is commonly referred to as the computer in the vehicle or it may be built into the ABS control unit (or module) 64 or the controller 110 may be a separate unit in communication with the ABS module 64 which controls many of the functions of the system 100 in response to an input from the controller 110. Of course, the controller 110 may be an additional separate unit. More specifically, when the controller 110 is working in conjunction with the ABS system 60, the ABS controller or module 64 controls locking of pressure as directed by the controller 64 or controls the hydraulic modulator 66 in response to input from the controller 110. When the hydraulic modulator 66 is a piston-type modulator, pistons may be used to increase pressure in the system when the vehicle immobilization system 100 is activated as well as in some embodiments lock the fluid such that the brakes will remain locked once the pressure builds up, such as from the operation of the hydraulic modulator 66. The hydraulic modulator 66 may also be the additional locking valve assembly 114, or although not illustrated, a locking valve assembly may be added in addition to the hydraulic modulator 66 in FIG. 7. Of course any other ABS components capable of building pressure in the brake system may be used to create the pressure necessary to engage the brakes, thereby preventing the wheels from turning. In addition, any other ABS components capable of interrupting the flow of fluid back to the master cylinder from the brakes, thereby maintaining engagement of the brakes to prevent the wheels from turning, may be used in place of or in conjunction with the locking valve assembly 114.

In operation, an OEM vehicle including the vehicle immobilization system 100 as an original equipment option will generally receive one of the signals described above that the system is to be armed or activated. After confirming that the vehicle is in a stopped state or a safe state to activate the vehicle immobilization system, the controller 110, which may also be the ABS controller 64, may have a separate hydraulic piston 120, locking valve 114 or the ABS hydraulic modulator 66 build pressure in the brake assembly such that the brakes engage the calipers or drums to lock the wheels in place. Once the wheels are not able to turn, the system 100 would remain active until deactivated by an operator. Of course a vehicle having an ABS system may be activated as described in regards to an OEM vehicle not including ABS. In some embodiments, the user may still be required to build pressure in the brake system by pressing the brake pedal 42 until it reaches a specified point or a specified pressure is built and then the ABS hydraulic modulator 66 may cut off the fluid flow back to the master cylinder to maintain the pressure. Of course, an additional brake lock valve, such as the hydraulic piston 120 or locking valve 114, may be used.

The vehicle immobilization system may also be installed as an aftermarket option. In installation as an aftermarket option, the software on the ABS module or additional controller may interact with the ABS module to control the system as shown above in the ABS embodiment previously described. Furthermore, as an aftermarket option, the vehicle immobilization system 100 may also be implemented similar to the above described OEM version without ABS. However, it is expected that most aftermarket shops would not desire to tap directly into the ABS system 60 or change the control module or add an additional controller that interacts with the ABS system. Therefore, the vehicle immobilization system 100 as described below may be added as an aftermarket option to both vehicles having ABS and vehicles not having ABS without tapping into the ABS system.

The vehicle immobilization system still includes the controller 110 and remote 112 which interact with the brake system 40 to create a locked wheel position to prevent the wheels from turning. While there are many ways to implement this system 100 and a few are described below, generally the controller 110 needs to receive a signal that the system is to be activated as well as a signal that the vehicle is in a stopped status. It is expected that the activation signal will generally be a remote 112 capable of infrared, RF, or other communication method with the controller 110. However, as described above the controller 110 may look for certain operational conditions such as the vehicle coming to a stop through either a wheel sensor 62, a speedometer on the instrument panel 20, or even a brake signal 74 from the brake light 72 combined with notification that the vehicle is placed in park. Of course other signals may be used such as the signals described above.

The controller 110 also needs a pressure in the brake system to be built to the point that the brakes prevent the wheels from moving. This pressure may be built manually by the operator, for example, as they hold the brake pedal to keep the car in a stopped position from moving forward while the vehicle is placed in park. It would be expected of course that the operator would need to hold the brake pedal depressed for a short time period after the vehicle is placed in park to give time for the exemplary brake lock 120 which locks the vehicle hydraulically or a motor 90 engaging a shaft 92 which is received in a mechanism 126 on the brake arm. Of course as described above, the controller 110 may also have the ABS hydraulic modulator 66 lock the fluid in place. With the brakes locked, the vehicle immobilization system is active. The operator may then exit the vehicle. Generally, it is expected that the operator, while the vehicle immobilization system 100 is arming or activating, that the operator will need to remain in the vehicle or activate it from within the vehicle. However, in systems that interface with the ABS system 60 or a separate pressure build system such as an additional hydraulic piston attached to the brake assembly (not illustrated) or vehicles that are drive by wire to the brake which could activate electronically the master cylinder, the driver may activate the system upon exiting the vehicle as part of the process by pressing the button to lock the doors which activates an alarm potentially as well as the vehicle immobilization system 100.

Vehicles having electrically actuated parking brakes that cause all four wheels to lock, such as by locking the drive shaft of a four wheel drive vehicle in place, may use the parking brake activation in place of the hydraulic system described above. Of course, the controller 110 would still need an input that initiates the activation sequence as well as an input that the vehicle is in a stopped state.

The vehicle immobilization system allows easy use of maintaining the pressure in the fluid lines even when the pressure drops due to ambient temperature changes, a leak within the brake system or seepage within the brake system. More specifically, by monitoring the pressure, the system 100 knows when to add pressure to the fluid lines through the use of a separate pressure building mechanism 200 or a hydraulic modulator (ABS pump) on the ABS system.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A vehicle having a braking system capable of preventing each vehicle wheel from turning, said braking system including brakes, fluid lines and a master cylinder, and a vehicle immobilization system interfacing with said braking system, said vehicle immobilization system comprising:
a controller capable of receiving an activation input and a vehicle stop condition input, said controller providing an engagement output signal; and
a brake mechanism capable of maintaining fluid pressure within the fluid lines in response to said engagement output signal.

2. The vehicle immobilization system of claim 1 wherein said brake mechanism is a valve assembly coupled to the fluid lines and wherein said valve assembly is in communication with said controller and prevents passage of fluid in response to said engagement output signal.

3. The vehicle immobilization system of claim 1 wherein said brake mechanism is an ABS hydraulic modulator and wherein said ABS hydraulic modulator is in communication with said controller and prevents the passage of fluid in response to said engagement output signal.

4. The vehicle immobilization system of claim 3 further including a pressure monitor capable of communicating the pressure in at least one of the hydraulic lines to said controller and wherein said hydraulic modulator is capable of building pressure in said hydraulic lines in response to an increase pressure output signal from said controller.

5. The vehicle immobilization system of claim 1 further including a pressure generating device in communication with said controller and a pressure monitoring device capable of monitoring the pressure within the hydraulic lines and wherein said pressure generating device is capable of generating pressure within the hydraulic lines in response to a low pressure signal from said pressure monitoring device.

6. The vehicle immobilization system of claim 1 further including a remote device capable of sending an engagement request signal and wherein said controller is capable of receiving said engagement request signal and various vehicle status signals.

7. The vehicle immobilization system of claim 1 wherein said brake mechanism is a shaft that engages a brake arm and retains the brake arm in a compressed state.

8. The vehicle immobilization system of claim 1 wherein the vehicle stop condition input is a received brake light signal.

9. A method of immobilizing a vehicle having brake system including brakes, and fluid lines, said method comprising:
receiving an engagement request with a controller;
verifying the vehicle is in a stopped state by the controller;
providing an engagement signal by said controller;
maintaining the brakes on the vehicle in an engaged position to prevent the wheels from turning in response to said engagement signal.

10. The method of claim 9 wherein said step of verifying said vehicle is in a stopped state by said controller further includes the step of receiving at least one signal selected from the group consisting of an ignition off signal, a transmission status signal of park, a brake pressure signal, a GPS stopped signal; an accelerometer signal; a brake light signal; an engine rpm signal of zero; a wheel speed signal of zero; a parking brake on signal; a change in transmission status signal; and an ABS module signal.

11. The method of claim 9 wherein said step of verifying said vehicle is in a stopped state by said controller further includes the step of receiving at least two signals selected from the group consisting of an ignition off signal, a transmission status signal of park, a brake pressure signal, a GPS stopped signal; an accelerometer signal; a brake light signal; an engine rpm signal of zero; a wheel speed signal of zero; a parking brake on signal; a change in transmission status signal; and an ABS module signal.

12. The method of claim 9 further including a step of engaging the brakes to prevent the wheels from turning before said step of maintaining the brakes in engagement.

13. The method of claim 12 wherein said step of engaging the brakes further includes the step of interrupting fluid flow within the hydraulic lines on a vehicle extending between a master cylinder and the brakes.

14. The method of claim 12 wherein said step of engaging the brakes further includes the step of creating pressure within hydraulic lines on a vehicle extending between a master cylinder and the brakes.

15. The method of claim 9 wherein said step of maintaining further includes the step of building pressure in response to a low pressure signal.

16. The method of claim 12 wherein said step of building pressure further includes the step of communicating a low pressure signal to a hydraulic modulator and wherein said hydraulic modulator builds pressure in the fluid lines.

17. The method of claim 9 wherein said step of verifying said vehicle is in a stopped state includes the step of receiving a brake light on signal.

18. The method of claim 17 wherein said step of verifying said vehicle is in a stopped state further includes receiving a second verification vehicle stopped state signal.

19. The method of claim 18 wherein said vehicle stopped state signal is one of an ignition off signal, a vehicle speed of zero signal or an engine rpm of zero signal.

20. The method of claim 9 wherein said step of maintaining engagement further includes the step of monitoring pressure within fluid lines.

21. The method of claim 20 wherein said step of maintaining engagement further includes the step of building pressure in response to a low pressure signal.

22. A vehicle immobilization system for a vehicle having a brake system capable of preventing each vehicle wheel from turning, said braking system including brakes, fluid lines and a master cylinder and an ABS system including an ABS controller, a hydraulic modulator and at least one wheel rotation sensor, said vehicle immobilization system comprising:
a module within said ABS controller capable of receiving an activation input and a vehicle stop condition input, said module providing an engagement output signal to said hydraulic modulator and wherein said hydraulic modulator in response to said engagement signal maintains fluid pressure within said fluid lines.

23. The vehicle immobilization system of claim 22 wherein said hydraulic modulator is capable of increasing fluid pressure in the fluid lines in response to said engagement signal.

24. The vehicle immobilization system of claim 22 wherein said vehicle stop condition input is selected from the group consisting of an ignition off signal, a transmission status signal of park, a brake pressure signal, a GPS stopped signal; an accelerometer signal; a brake light signal; an engine rpm signal of zero; a wheel speed signal of zero; a parking brake on signal; a change in transmission status signal; and an ABS module signal.
